(19) United States
(12) Patent Application Publication
(10) Pub. No.: US 2006/0174197 A1
(43) Pub. Date: Aug. 3, 2006

(54) Interactive visual interface for websites and other electronic media that will deliver both content and push content such as advertising

(76) Inventors: David McIntyre, New York, NY (US); Mike Hartley, New York, NY (US)

Correspondence Address: David McIntyre, 249 West 29th st #3e, New York, NY, 10001, US

(21) Appl. No.: 11/346,061

(22) Filed: Feb. 1, 2006

Related U.S. Application Data
(60) Provisional application No. 60/649,038, filed on Feb. 1, 2005.

(51) Int. Cl. G06F 17/24; G06F 3/00

(52) U.S. Cl. 715/530; 715/764; 715/515

(57) ABSTRACT

A system and method of designing electronic media, such as websites, that creates forced breaks in the viewing process. This system and method enables the delivery of advertisements or other push content to the viewer during said forced break.

Any device that is used to display pictures, sound or text. Such as the websites displayed on a computer screen, or dvd's displayed on a television or a computer screen, or content displayed on a PDA would all constitute electronic media.

### SUMARY

The invention is a method of delivering push content within electronic media. Delivery of said push content is achieved by the interaction of various component presented within the said electronic media. While these components can be presented in many different visual forms, they have specific functions that remain consistent. It is the unique functionality and interaction of these components that is constitutes this invention.

### BACKGROUND

Online advertising is growing in popularity, however the type advertising opportunities currently available, such as banner ads, popup ads and interstitial ads are either too small or too intrusive. There is need for a new way of calling and displaying advertisements and other push content on websites and other electronic media.

### DESCRIPTION

Three different components are presented on the display of the electronic media. These components are; 1. The Contents 2. The Navigation and Contents Menu 3. The Push Content. Through the interaction of these components, as described below, media designers will be able to build interactive interfaces that will to deliver push content in a new and more effective manner.

Explanation and description of each component.

1. The Contents.

The content is best described as the words and or pictures and or moving images and or sound that constitute the reason a viewer is viewing said media. If the electronic media is a newspaper's website, then the content is all the news and features that are available for viewing at said website. The contents will normally be made up of numerous items or features, for instance a newspaper's website may have hundreds of news and general interest stories. For the purpose of this invention each of these stories would be described as an item of content.

2. The Navigation and Contents Menu.

The navigation is the means of moving around the said media, advancing from one page to the next, linking from one item of content to an other.

The contents menu is list of the contents that are available to be viewed within said media. The contents menu is like the ‘table of contents’ of a book or magazine. Collectively the navigation and the contents menu', whether they be text, images or sound, are the means by which the viewer moves around the said media.

3. The Push Content.

This is any content that is presented to the viewer with out being requested by the viewer, it may be words and or pictures and or moving images and or sound that will appear without being directly requested by the viewer. The push content could be many things including an advertisement or a promotion or a special offer or a coming soon feature.

### Operation

This invention creates two different opportunities to deliver push content.

The first opportunity to deliver push content is when a viewer is looking at an given item of content. This is achieved by first dividing an item of content into a number of different page views that are viewed in a linear fashion, one page view followed by another. This differers from traditional web design where an item of content might be presented as a single page that the viewer would scroll through. By breaking an item of content into a number of individual page views we create a manner of viewing in which the viewer advances through the items of content much the way a reader might advance through the pages of a book. To move through the content the viewer uses the navigation to advance from one page view to the next or to return to the previous page view, at any time in this sequence an ad could be delivered. For instance if the content was a eight page written article, after four pages an ad might appear when the viewer activates the navigation to advance to page five, with the push content on screen the viewer would then click again to advanced to ‘real’ page 5. While push content could be delivered after every page of a given item of content it would be up to the individual media designer to decide what was the most acceptable quantity of push content to deliver.

The second opportunity to deliver push content comes when the viewer is finished viewing a given item of content, this may be when they have reached the final page of a given item of content or when they have decided they no longer wish to continue looking at the current item of content. At this time the viewer will select a link that is part of the navigation component that brings onto screen the contents menu. When the contents menu is on screen push content is delivered to that part of the screen that is not being used to display the contents menu. The contents menu could be designed in such a way as to enable delivering push content that is as large as full-screen in size. The contents menu might display a number of categories, for instance a newspaper's website might have national and International categories, when the viewer activated one of these different categories within the contents menu new push content could be delivered. Thus when the viewers is navigating thought the contents menu other push content can de delivered to the area of the screen not occupied by the contents menu. This new push content can be delivered in sync with the viewer as they click on various sections or subsection of the contents menu or it could change independently while the viewer is in the contents menu.

### Detailed Description to Build a Sample Application

The instructions are for construction of a simple web site that has fifteen items of contents and five items of push content.

While this example of the push content design and delivery system is very simple, there are infinite possibilities and variations for the visual representation of the individual components.

Five of the content items are written essays, each is 1000 words long, the other 9 content items are photo essays that each features 6 photographs the final item is the ‘splash’ page or the opening page when the site is first accessed

The written essays are broken up into individual pages, each page will show 250 words. the pages will be named

story1page1, story1page2, story1page3, story1page4

story2page1, story2page2, story2page3, story2page4

story3page1, story3page2, story3page3, story3page4

story4page1, story4page2, story4page3, story4page4

The picture stories are divided into 6 pages with a picture on each page

picturestory1page1, picturestory1page2, picturestory1page3,

picturestory1page4, picturestory1page5, picturestory1page6

picturestory2page1, picturestory2page2, picturestory2page3,

picturestory2page4, picturestory2page5, picturestory2page6

picturestory3page1, picturestory3page2, picturestory3page3,

picturestory3page4, picturestory3page5, picturestory3page6

picturestory4page1, picturestory4page2, picturestory4page3,

picturestory4page4, picturestory4page5, picturestory4page6

picturestory5page1, picturestory5page2, picturestory5page3,

picturestory5page4, picturestory5page5, picturestory5page6

picturestory6page1, picturestory6page2, picturestory6page3,

picturestory6page4, picturestory6page5, picturestory6page6

Each item of push content will have it's own page, these are named:

pushcontent 1

pushcontent 2

pushcontent 3

pushcontent 4

pushcontent 5

The navigation has a number of controls that are available or active depending on the activity of the viewer.

these are:

view next page

view previous page

view contents

info

The contents menu is a drop down menu. When it is first selected, by clicking on a link in the navigation bar, it show two options; essays and photo stories. When either of these options is selected it expands to show either the 5 essay stories or the 10 photo stories. At it's biggest the menu will cover one third of the screen and will be positioned on the left of the screen.

When the site is first accessed two items are visible, the navigation bar and the cover page.

When the contents link located on the navigation bar is clicked two actions take place, first pushcontent1 is displayed in place of the cover and the drop down menu displaying the two choices (essays and photo stories) is activated. If one of the two subcategories is selected (essay or photo) two actions take place, firstly pushcontent2 is displayed in place of pushcontent1 and the menu expands to reveal the contents of the subcategories. If story one is selected from the stories menu then story1page1 will be displayed in place or pushcontent2. At this time the links ‘view next page’ will become active in the navigation bar. If this is selected then story1page2 will be displayed and the link view last page will become active in the navigation bar. By this means the viewer can easily navigate thought the story page by page until reaching story1page4. At this time the link view next page would deliver pushcontent3. If this was selected and the viewer had pushcontent3 on screen the link in the navigation bar to view last page would return the page story1page4. If at any time the viewer selects the contents menu the next available push content is displayed. For instance if the viewer selects the contents link while pushcontent3 is on screen push content 4 would be delivered together with the drop down menu.

1. A method of designing websites that creates brakes in the viewing process whereby content not requested by the viewer is displayed in said breaks, comprising of:
a. Content to be displayed
b. A navigation interface

2. A method of displaying content within an electronic media environment comprising of:
a. Content that is presented as a series of page views
b. A means by which the viewer can advance from one said page view another said page view.
c. A means of listing the contents available within said electronic media
d. A means of selecting and bringing in to into view the related content.

3. A method of displaying content within an electronic media environment, where some of the said content is displayed without being requested by the viewer comprising of:
a. Content that is requested by the viewer.
b. Content that is not requested by the viewer.
c. A means by which the viewer can advance from one page of content to another page of content.
d. A means by which content not requested by the viewer is displayed instead of the content that has been requested.
h. A means of listing the contents available within said electronic media.
g. A means of displaying content not requested by the viewer when said list of contents is displayed.
i. A means of selecting and bringing into view said contents.
h. A means of changing the content not requested by the viewer while the list of contents is displayed.
